(19) United States
(12) Patent Application Publication
(10) Pub. No.: US 2013/0268345 A1
(43) Pub. Date: Oct. 10, 2013

(54) METHODS FOR AND APPARATUS FOR AUTOMATED PRESALE KIOSK

(71) Applicant: Robert Davidson, New York, NY (US)

(72) Inventor: Robert Davidson, New York, NY (US)

(21) Appl. No.: 13/607,752

(22) Filed: Sep. 9, 2012

Related U.S. Application Data
(60) Provisional application No. 61/620,472, filed on Apr. 5, 2012.

(51) Int. Cl. G06Q 30/06

(52) U.S. Cl. CPC G06Q 30/0623
USPC 705/14.37; 705/21

(57) ABSTRACT

The present invention provides methods and apparatus for providing sales assistance to a Purchaser located within a store location. The present invention includes a Kiosk for fielding inquiries about a product included in the store inventory. A Purchaser may also use a mobile device to receive sales assistance. A Sales Incentive Artifact may be used to encourage a Purchaser to complete a Purchase at the store location.

### CROSS REFERENCE TO RELATED APPLICATIONS

The present application claims priority to provisional patent application Ser. No. 61/620,472, filed, Apr. 5, 2012 and entitled, “Methods and Apparatus for Automated Presale Kiosk”, the contents of which are relied upon and incorporated by reference.

### FIELD OF THE INVENTION

The present invention relates to automated methods and apparatus for providing interactive presale assessment of a buyer's needs. More specifically, the present invention provides a kiosk working in conjunction with a mobile phone device for facilitating sales at a local level.

### BACKGROUND OF THE INVENTION

Sales assistance for customers at a brick and mortar type store is increasingly challenging. One attraction to brick and mortar type stores is a desire by a customer to engage a knowledgeable human being and also peruse products for potential consumption. However, a large number of available products may introduce confusion to a buyer as to which product to purchase. Larger numbers of customers during peak shopping times makes it difficult for sales staff to efficiently address customer needs and also determine which customers are high value customers.

Brick and mortar sales teams also compete with virtual online storefronts. Virtual online stores often provide for automatons to answer online questions and may even include a live operator to enter into text dialogues with a customer. Today's marketplace therefore allows Purchasers to complete a purchase of a good or service at a brick and mortar store or via an online storefront. Many advantages exist for both venues.

Online Products are often very competitive in price and allow a Purchaser to compare pricing and availability from vendors in many places throughout the world. In addition, online vendors are often not required to collect state sales tax, which provides an additional incentive for a Purchaser to purchase a Product online. Online shopping may also be conducted from almost anywhere, even from within the aisle of a store in which a Purchaser went to view a Product, or a Purchasers home.

Local Vendors compete with online vendors by offering competing advantages. At a Local Vendor, a Purchaser may conduct a firsthand inspection of a look and feel of a Product and determine which Product best suits the Purchaser's needs. In addition, a Local Vendor provides immediate access to the Product wherein the Purchaser receives it without delay. In store stock availability means that a Local Vendor typically does not charge any shipping costs or restocking fees, which an online vendor may. Finally, if so inclined, a Local Vendor may provide excellent customer service and create a relationship with a Purchaser wherein, by comparison an online experience is often impersonal. The challenge therefore becomes how to provide such excellent service.

Therefore it would be helpful to provide a way for a Local Vendor to provide a more efficient sales experience within a brick and mortar store and in some embodiments, also compete pricewise with an online vendor.

### SUMMARY OF THE INVENTION

Accordingly, the present invention provides methods and apparatus for combining favorable aspects of a brick and mortar store with online efficiency. An interactive customer kiosk works in conjunction with a data base descriptive of a product line maintained by a brick and mortar store and a Buyer's mobile device, such as a cellular phone. The kiosk includes a processor operative with executable software for vetting customers and queuing up appropriate sales help for respective Buyers.

The kiosk may present information to a Buyer about specific products carried by the store and prepare Sales Help with knowledge of the Buyer's interests. In some embodiments, the kiosk provides a Buyer with a priority token on their mobile device.

As taught by the present invention, a kiosk may work in conjunction with a mobile phone device for determining an area of product interest to a potential buyer, concerns the buyer may have, and incentives for the buyer to complete a purchase on a local level.

Various embodiments of a priority token may include a simple sequential order for a next Buyer to be assisted by in store sales persons, and/or a profile detailing a type of product a Buyer is interested in and an indication of a type of assistance the Buyer is seeking.

In some embodiments, the present invention also assists in making local brick and mortar type shopping more competitive with an online purchase experience. The present invention may provide a Purchase Incentive, such as a one day in store coupon related to a product inquiry made by a Buyer. The Purchase Incentive may be provided via a virtual artifact displayable on a Purchaser's mobile device.

Input into the kiosk may be used to generate an automated request from a Purchaser for a Purchase Incentive and automatically provide a Purchase Incentive to the Purchaser for a purchase at a vendor local to the Purchaser's location. The Purchase Incentive may be received independent of a Point of Sale system utilized by the Local Vendor.

Generally, a Purchase Incentive includes executable software operative via a processor included in a Purchaser's Mobile Device and in communication with an online server. A Purchaser's location may be determined for example via Global Positioning Satellite (GPS) coordinates, an address input into a user interactive interface (UII), accelerometers used in conjunction with a GPS coordinate, or other coordinate system.

A database is maintained that includes data descriptive of: store locations for a particular vendor, products stocked by the vendor and Purchase Incentives available for purchases made with the vendor.

Automated apparatus may receive information descriptive of one or more of: a Purchaser, a location of the Purchaser, a desired place of purchase for the Purchaser, and Purchase Priorities specific to the Purchaser. The automated apparatus provides one or both of a Priority Artifact and Purchase Incentives, such as, for example, a Third Party Discount Artifacts (TPDA), to the Purchaser. A Priority Artifact provides an indication of when and where the Purchaser will receive sales assistance and a Third Party Discount Artifact may provide one or both of: a discount and remuneration based on completion of a Purchase of a Product or Service from a vendor local to the Purchaser.

In some embodiments, input may be received into a computer server via a distributed network and processed to generate an association of one or more Products or Services available from a specific Vendor local to a Purchaser. The computer server may make available to the Purchaser a Priority Artifact and a TPDA for use with a purchase from a vendor identified as being local to the Purchaser.

A software engine included in the server may be used to match specific sales assistance and TPDAs with a Product a Purchaser has shown interest in.

In some preferred embodiments, the server provides a Purchaser with guidance relating to a Purchase based upon the Purchaser Priorities or preferences, Products that are available that are local to the Purchaser and a value associated with available TPDAs. The server may thereby provide a recommendation on a best deal for the Purchase based upon the Purchaser's specific needs, preferences, location and Product availability.

A related aspect of the present invention provides methods and apparatus for generating and presenting an interface which facilitates a user in providing information to the server and receiving a TPDA based upon the provided information. The interface may be presented over a distributed network, such as the Internet, and may be accessed with any network access device, such as, by way of example: a personal computer, a laptop, a mobile phone, a tablet device, or other device with a user interface that facilitates access to Internet uniform resource locators.

In some respects, the present invention may be implemented to determine Purchaser Priorities, such as, for example, what matters most to a Purchaser, and correlate a Purchase Incentive type to the determination of which Product to purchase with what matters most to a user. In some preferred embodiments, steps directed to determining what matters most to a user are determined via question and answer input provided about the Purchaser.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1A illustrates a block diagram of some aspects of the present invention.

FIG. 1B-C illustrate additional exemplary embodiments of a kiosk that may be used in some implementations of the present invention.

FIG. 2 illustrates a flow diagram of method steps that may be used to implement some embodiments of the present invention.

FIG. 3 illustrates a block diagram of a purchase process that may be used to implement embodiments of the present invention.

FIG. 4 illustrates diagram of additional method steps that may be used to implement some embodiments of the present invention.

FIG. 5 illustrates diagram of additional method steps that may be used to implement some embodiments of the present invention.

FIG. 6 illustrates exemplary apparatus for implementing aspects of the present invention.

FIG. 7 illustrates a functional diagram of some aspects of the present invention.

### DETAILED DESCRIPTION OF PREFERRED EMBODIMENTS

The present invention provides an automated system including methods and apparatus for providing presale assistance to a Purchaser via one or both of a Kiosk apparatus and a virtual kiosk presentable via a user interactive screen, such as a screen on a mobile phone or tablet device. In preferred embodiments, a Purchaser will receive a Priority Artifact, such as, for example, one or more of: a sequential number; a bar code, a hash mark, a serialized number; and a color coded token.

The Priority Artifact may be used to indicate an order of sales assistance. In addition, in some embodiments, the Priority Artifact may indicate one or more of: a type of assistance requested, a product type for which assistance is requested, a time that assistance may be provided, a store location at which assistance is requested.

In another aspect of the present invention, some embodiments may include provision of a Purchase Incentive to a Purchaser based upon input received into a Kiosk. The Purchase Incentive may be received, for example, on a mobile device, such as a cellular phone.

Some preferred embodiments also allow for a Purchase Incentive to be redeemed irrespective of, and independent of, a Point of Sale device or system utilized by a Local Vendor. The independent nature of the present invention thereby enables ubiquitous vendor inclusion without the need for upgrades to Local Vendor POS hardware or software. The Purchase Incentive provides an incentive to a Purchaser to make a purchase at a vendor local to a Purchaser as compared to an online vendor. As presented herein, various embodiments of the present invention will be described, followed by some specific examples of various components that can be utilized to implement the embodiments.

Automated apparatus, such as a computer server running executable software determines which Products are most likely available to the Purchaser in an area generally local to the Purchaser. In some embodiments, a Purchaser may indicate a geographic range that may be considered local.

The automated apparatus is additionally functional to transmit to the Purchaser data descriptive of one or more merchants that are Local to the Purchaser. The automated apparatus also transmits an artifact which provides an incentive for the Purchaser to complete a purchase of the recommended Product from the Local merchant.

### GLOSSARY

As used herein the following terms will have the following associated meaning:

“Buying Context” includes circumstantial data related to a Purchase.

“Engine” an apparatus including a processor that executes a software process to receive one or more inputs, process the inputs, and generate an output based upon the inputs. An engine may include one or more servers or be a generated on a server farm.

“Kiosk” as used herein shall mean one or both of: a stand-alone device and a virtual presentation providing information and services on a human interactive screen, such as for example a mobile phone screen, a tablet screen and a computer screen.

“Local” in geographic proximity reasonable to travel to make a purchase based upon objective and subjective aspects of a purchase, which may include, for example a size of a purchase, the availability of a Product to be purchased and timing of when a Product is needed.

“Mobile Device” (which may also be referred as a smart phone, mobile phone, handheld device, handheld computer, or a handheld) as used herein shall mean a small handheld computing device, including a wireless communications capability, display screen and a user interactive apparatus such as a touch screen or a keyboard.

“Product” for the sake of simplicity in this discussion, as used herein a Product shall mean one or more of: a tangible item, machine or device; an intangible conveyance such as knowledge, know how or data stream; and a Service performed (as defined below).

“Purchaser” or multiple “Purchasers” as used herein shall mean one or more individuals, or a succinctly defined organization that makes or contemplates making a purchase.

“Purchase Incentive” as used herein shall mean one or more financial benefits conveyed upon a Purchaser based upon consummation of a purchase of a Product. A Purchase Incentive may include, for example, a discount on a purchase price, a credit issued to a charge account utilized to make a purchase, a refund of a sales tax, refund of a sales tax plus some predetermined amount, and refund of a sum certain.

“Sales Priority Artifact” as used herein shall mean a virtual artifact displayable on a mobile device, such as a cellular phone or tablet computer. The artifact will convey information relating to a priority for receiving sales help. Some examples of a Sales Priority Artifact include one or more of: a number indicative of chronological order; a sequential number; a barcode; a hashmark; a color coding; and an appointment time and location.

“Service” as used herein shall mean an action performed at the request of a Purchaser.

“Third Party Purchase Incentive” (“TPPI”) as used herein shall mean a Purchase Incentive provided by a party other than a vendor with which the Purchase Incentive may be realized.

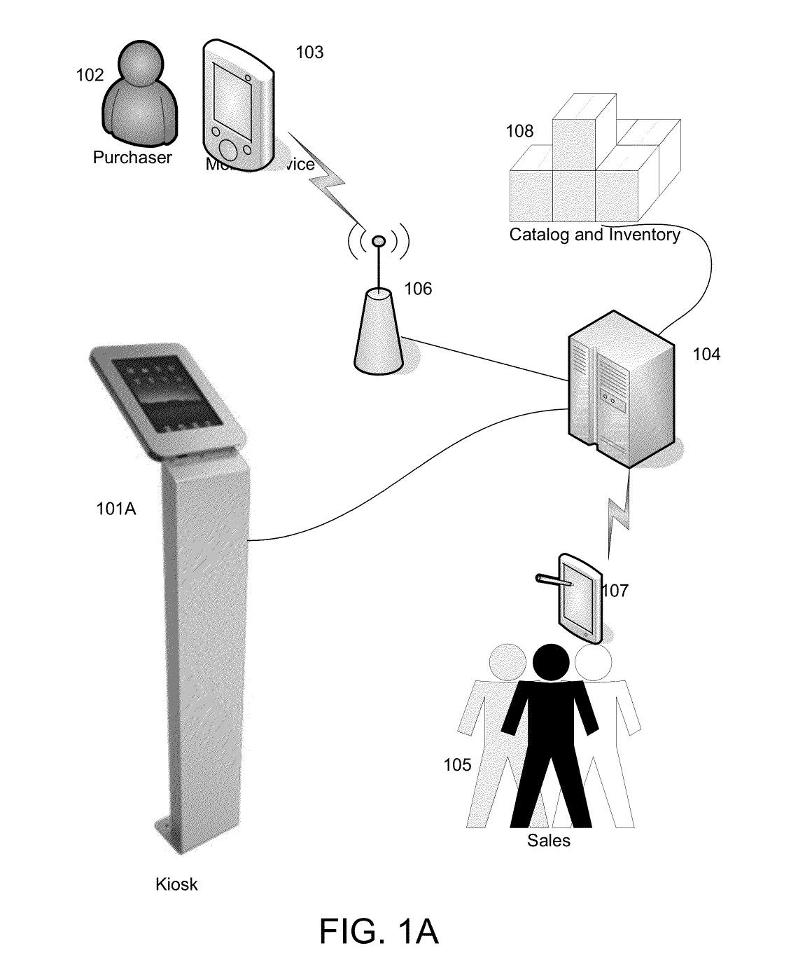

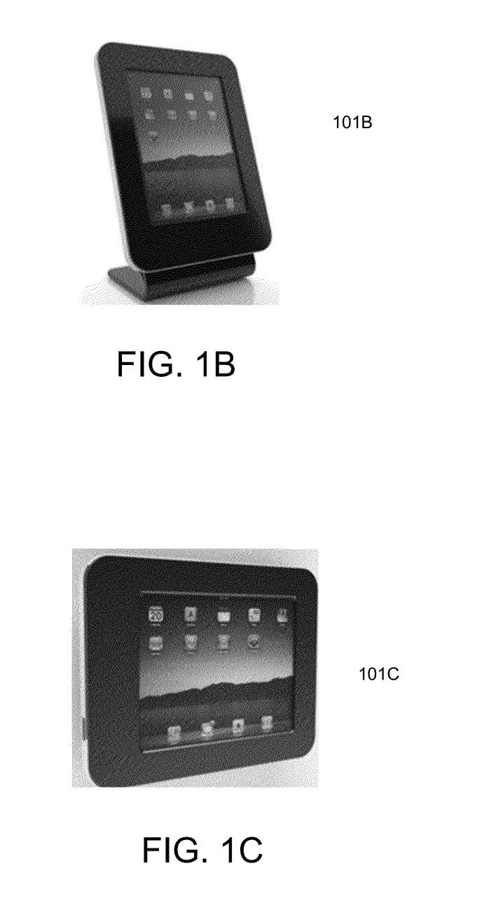

Referring now to FIGS. 1A-C, diagrams illustrates aspects of the present invention wherein a Kiosk 101A-C is used in conjunction with a Presale Server 104 in order to facilitate a sales experience of a Purchaser 102 and a Salesperson 105. The Kiosk 101A-101C includes a user interactive display that may receive input from a Purchaser 102 and present to the Purchaser 102 one or both of a Sales Priority Artifact and a suggested product for Purchase. Various embodiments of a Kiosk 101A-101C are illustrated which utilize a tablet type display, other types of interactive user devices are also within the scope of the present invention, The Sales Priority Artifact includes a virtual artifact displayable on a Purchaser 102 Mobile Device 103, such as a cellular phone or tablet computer. The artifact will convey information relating to a priority for receiving sales help. Some examples of a Sales Priority Artifact include one or more of: a number indicative of chronological order; a sequential number; a barcode; a hashmark; a color coding; and an appointment time and location.

A Sales Priority Artifact may be used to manage an order in which sales help is provided by Sales Persons 105 to Purchasers 101. The Sales Priority Artifact may be a simple sequential number or include a “smart” artifact. A smart artifact conveys information related to a particular Purchaser 102. In some embodiments, the information may include, for example, a list of Products of interest to a Purchaser 102, such as a Lela list or a general area of product interest to the Purchaser.

In additional embodiments, a Sales Priority Artifact may include more detailed information, such as, a customer loyalty status indicating how often a Purchaser 102 frequents a store, or an aggregate sales dollar amount a Purchaser 102 has reached. Additional examples of “smart” information may include a product type the Purchaser 102 is interested in and a type of assistance the Purchaser is seeking from a Sales Person 105. Although the generic term Sales Person 105 is used herein, according to the present invention, a Sales Person 105 may also include technical support, service technicians, customer service representatives and the like.

A suggested product for purchase will include a product offered for sale by a store in which the Kiosk 101A-101C is located. Offered for sale may include one or more of: a product physically in stock at a brick and mortar location; a product carried by a chain associated with the store at which the Kiosk 101A-101C is located, a product determined to be suitable for the Purchaser 102 according to Emotional Motivators; and a Product associated with a Lela list maintained by the Purchaser 102.

The Kiosk 101A-101C may be in logical communication with the Presale Server 104. Communication may be accomplished, for example via known data networking technology. The Presale Server 104 may include one or more databases that may be accessed by the Kiosk 101A-C to exchange information such as, one or more of: a Sales Priority Artifact; an inventory of products 108 wherein the inventory of products may include products catalogued by a store chain and/or products in stock at a brick and mortar location; a Lela list associated with a Purchaser 102; a wait time for access to a Sales Person 105; a scheduled appointment time for assistance from a Sales Person 105; or other data.

The Presale Server 104 may also be in logical communication with a cellular device 103 associated with the Purchaser 102. The cellular device may be in communication with the Presale Server 104 via one or more of: a cellular network such as, for example a 3G or 4G network; or a Wi Fi network. The cellular device 103 may also receive data including one or more of: a Sales Priority Artifact; an inventory of products 108 wherein the inventory of products may include products catalogued by a store chain and/or products in stock at a brick and mortar location; a Lela list associated with a Purchaser 102; a wait time for access to a Sales Person 105; a scheduled appointment time for assistance from a Sales Person 105; or other data.

In some embodiments, the cellular device 103 may transmit global positioning satellite data to the Presale Server 104 including a description of where the Purchaser 102 is located. The location of the Purchaser 102 may assist a Sales Person 105 in locating the Purchaser 102. The GPS location may also be used to reference which brick and mortar store location a Purchaser 102 is patronizing, and provide inventory information for products located at that store. In some embodiments, an Internet Protocol address (IP address) may also be used to determine a location of a Purchaser.

One or both of the Kiosk 101A-101C and the Presale Server 104 may recommend products to a Purchaser 102 according to one or both of: Emotional Motivators associated with the Purchaser 102 and incentives provided to purchase a particular product. Emotional Motivators are described more fully below and in related patent applications. Incentives are described more fully herein.

Suggested products may also include products that a Purchaser has seen in a store and identified via an electronic record. The electronic record may include, for example, a scan of a product code, such as a SKU number (stock keeping number) or a digital image of the product. A suggested product list, such as, for example a Lela List may also be persistent and be maintained through multiple shopping experiences. Shopping experiences may include experiences within a brick and mortar store, online and in the general marketplace.

In the discussion below, method steps that may be implemented in some embodiments are presented. The steps are not limited to any particular order unless other specified herein.

FIG. 1B illustrates a countertop type kiosk and FIG. 1C illustrates a wall mountable kiosk, all of which are within the scope of the present invention.

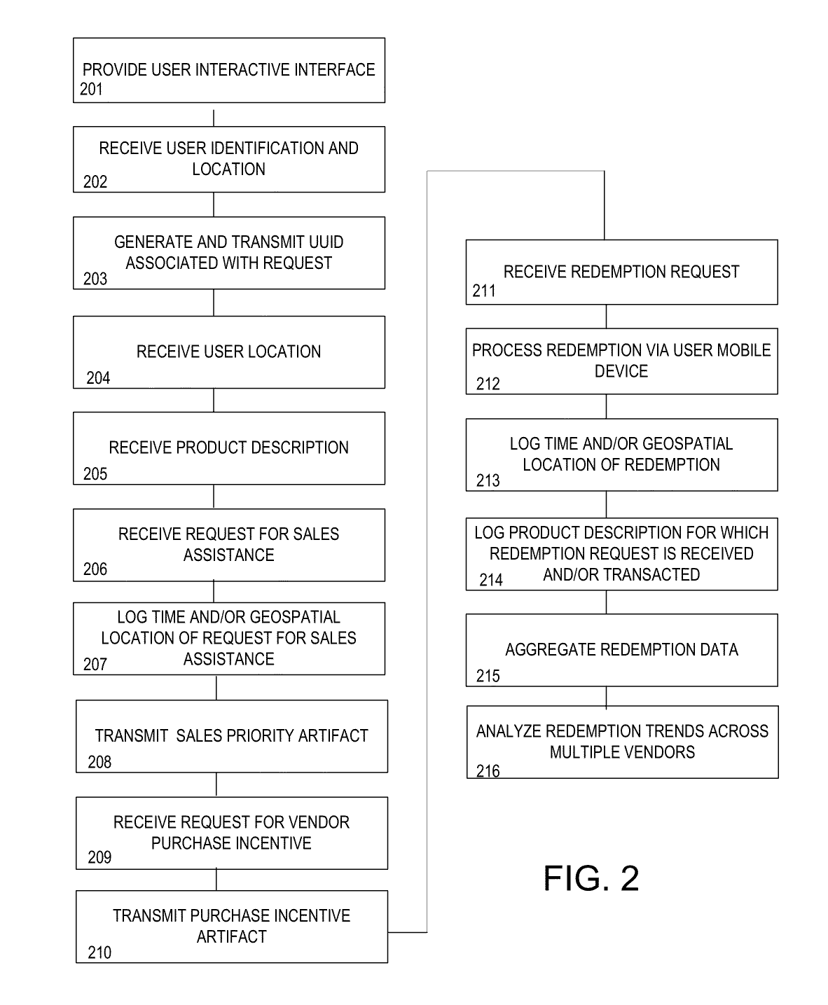

Referring now to FIG. 2, a flow diagram illustrates a method for an Engine that may be utilized in implementing some embodiments of the present invention. The engine may provide one or both of a Sales Priority Artifact and a Purchase Incentive, as well as other sales related information.

The engine may include, for example, one or more servers in logical communication with a distributed network, such as the Internet or another distributed digital network. The Engine provides information to a Purchaser related to products available to the Purchaser. A purchase may be either for Purchaser or for a beneficiary. The Purchaser may access the interactive interface across a communications network, such as the Internet or via a mobile phone network, such as, for example, a 3G or 4G network or other cellular or WiFi network.

At 202, the Engine receives user identification and a location of the user. The user identification may include for example an account number or user login. The user location may include GPS data transmitted from a Purchaser Mobile Device. In some embodiments, GPS coordinates may be tracked until a Purchaser Mobile Device enters into a building wherein a GPS signal may no longer be available to the Purchaser Mobile Device. After the GPS signal is no longer available, accelerometers may be that are included within the Mobile Device to track movement within the building. Movement within the building, for example, may indicate an aisle in which a Purchaser transmits a request for a Purchase Incentive Artifact.

At 203, in some embodiments, each request will be associated with a unique identifier, such a universally unique identifier (UUID). The UUID may be generated by the Engine. At 204, The Engine may receive data indicative of a location from which a User Mobile Device is making a request for a Purchase Incentive Artifact. The location may be, for example, via GPS coordinates or User input.

At 205 the Engine may receive a description of a Product for which the Purchaser is requesting one or both of sales assistance and a Purchase Incentive Artifact. At 206 the Engine may receive a request for sales assistance related. At 207, The Engine may log, or otherwise store digital data descriptive of, the time of receipt of the request for a sales assistance and in some embodiments, a geospatial location from which the request is made.

In some embodiments, the time and geospatial location are associated with a particular user making a request, in other embodiments, the time a geospatial location data may be aggregated with data descriptive of other requests.

At 208, the Engine will transmit to the Purchaser a Sales Priority Artifact indicative of timing of one or more of: an order of receipt of sales assistance; a type of sales assistance and a location of sales assistance.

In addition, in some embodiments, a Purchaser may be presented with a choice of multiple alternative Purchase Incentives and choose an incentive most amenable to each Particular Purchaser. For example, one Purchase Incentive may include, an Engine sponsor paying sales tax for the Purchaser, another Purchase Incentive may include free extended warranty, still another incentive may include a sum certain credit to an account used to complete a Purchase.

At 209, the Engine may receive a request for a specific vendor Purchase Incentive and at 210, the Engine transmits the Purchase Incentive to the Mobile Device associated with the Purchaser. The transmission may be for example, via a distributed network, such as the Internet, or via a cellular network, such as via 3G, 4g or other cellular standard.

At 211, the Engine may receive a redemption request for a Purchase Incentive. According to the present invention, at 212 the redemption request may come from a transmission from the Mobile Device associated with the Purchaser. In such embodiments, the request may be generated and transmitted irrespective of a POS terminal used by a Vendor to consummate a purchase of a Product. By way of non-limiting example, the redemption request may include one or more of: a code, pattern, number or other mark from a POS receipt; a scan of a code, pattern, number or other mark on a sticker affixed on or near a POS terminal; a scan of a card or coupon provided by a POS operator, wherein the card or coupon may include a code, pattern, number or other mark, an identifier from a card processor indicating that a purchase was completed, or other data indicative of the completion of a purchase of a Product with which a Purchase Incentive is associated.

At 213, in some embodiments, the Engine may receive data descriptive of and log one or both of: a time and geospatial location of a redemption of a Purchase Incentive. In preferred embodiments, data descriptive of the time and geospatial location of a redemption of a Purchase Incentive are transmitted from a Purchase Mobile Device. The time may be generated by a processor tracking a local time on the Mobile Device. The geospatial location may be derived from a GPS function included in the Mobile Device.

At 214, the Engine may log, or otherwise store data descriptive of a Product for which one or both of: a redemption request is received and a redemption request is transacted.

At 215, data descriptive of almost any facet of a Purchase Incentive Artifact generation and redemption may be aggregated and at 216 the aggregated data may be analyzed.

According to the present invention, because a Mobile Device operated by a Purchaser may be used to both request sales assistance and a Purchase Incentive Artifact. The Mobile Device may also be used to complete a Purchase Incentive transaction.

For example, the present invention allows for aggregation of data descriptive of a time, date and place of sales assistance requests which result in the generation of Sales Priority Artifacts, as well Product types for which the Sales Priority Artifacts are generated. In addition, the present invention teaches tracking whether sales assistance related to a Sales Priority Artifact is completed, and if it is completed, a time, date and place of provision of sales assistance, a type of sales assistance, as well a Product associated with the sales assistance. As such, analysis may include a time delta between a time of a sales assistance request and provision of the sales assistance.

Additional analysis may include Product types for which Sales Priority Artifacts are generated and/or redeemed, brands, vendors, purchase amounts, frequencies of Sales Priority Artifact requests, geographic areas, time of year, demographics associated with a geographic area in which Sales Priority Artifacts are requested, how sales assistance tracks against economic data associated with a geographic area, and tracking Sales Priority Artifact request and redemption against almost any other data.

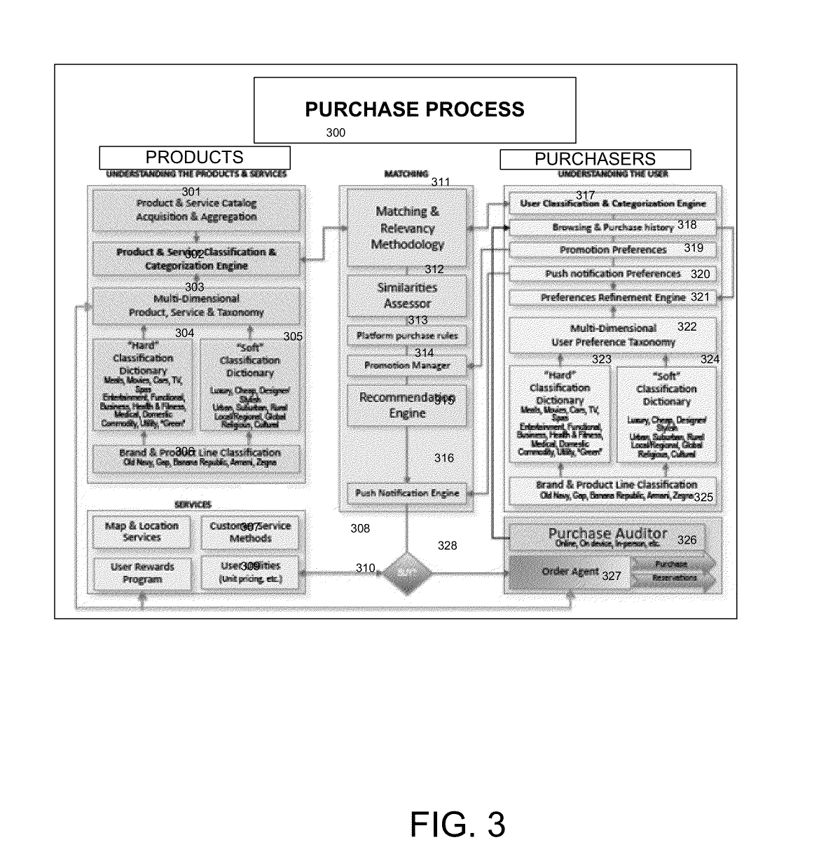

Referring now to FIG. 3, a process is presented according to some embodiments of the present invention that include the provision of a sales incentive along with a request for sales assistance. On a high level, the process includes method steps that may be implemented to practice novel aspects of the invention, including, for example, associating a time and place for requesting sales assistance and an incentive to make a purchase at a local level from a Local Vendor and consummating a transaction without a need to access a Local Vendor point of sale system (POS). At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and

Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, and Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, and cultural or other taxonomy or classification which is essentially relative to other taxonomies.

At 306, some exemplary embodiments may also include a recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310 user utilities that may also be an included Taxonomy.

At 317, data descriptive of a Purchaser or other user of a Purchase Incentive Artifact system may be placed into classifications and processed via a Categorization Engine for conducting analysis on the aggregated data. At 318, a browsing and/or purchase history may be associated with a particular user, or with a class of users, or with users in a specified geographic area, or during a specified time frame. At j319, advertising or Purchase Incentive promotions may be tracked, at 320, Push notifications may be tracked, at 321, preferences for a particular user, or group of users may also be ascertained from the aggregated data.

One or more multi-dimensional user preferences may be grouped according to taxonomies. The taxonomies may be based upon one or both of Hard Classifications and Soft Classifications. In addition, vendors, brands, and or products lines may be classified and analyzed according to Purchase Incentives requested and redeemed.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, and cultural or other taxonomy or classification which is essentially relative to other taxonomies.

Product and brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

A Purchaser may make a decision to execute a “Buy” action 328 and make a purchase. An order agent 327 may be used to implement a purchase instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

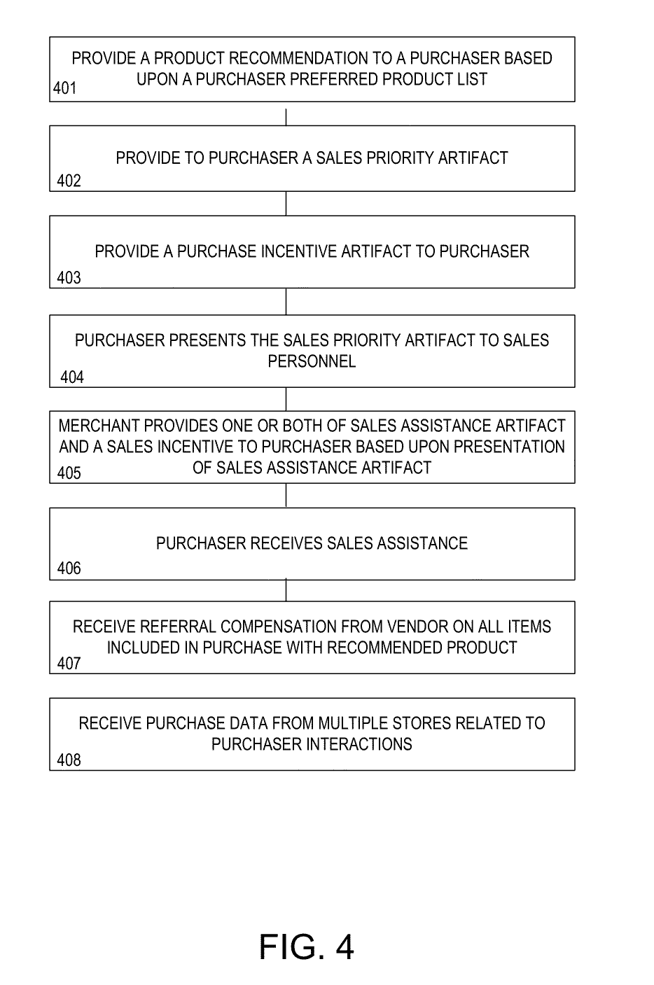

Referring now to FIG. 4, at 401 a server or other automated computer device, or online service, may provide functionality discussed herein. At 402, the server may provide to the Purchaser with a Sales Priority Artifact. Additional data such as inventory data, product specifications, and images of the Product may also be included if desired. At 403, a Purchase Incentive Artifact may also be transmitted to the Purchaser. One or both of the Sales Priority Artifact and the Purchase Incentive Artifact may include, for example, a coupon, a bar code, a UUID, a purchase code, a hash mark or other artifact identifiable by the Local merchant.

At 404, the Purchaser may present the incentive artifact to the Vendor at the time of purchase and, at 405; the Vendor may provide a discount price or other incentive to the

Purchaser. Other incentives may include, for example, store credit, accessories, service warranty or other items of value.

At 406, in some embodiments, a provider of the services described in the steps presented herein may receive a sales commission on a product recommended. At 407, some embodiments may also include a sales commission on an aggregate cost of all products included in a Purchase with a recommended product. Sales commission may be paid, for example by one or more of: a vendor, a distributor and a manufacturer.

At 408, in some preferred embodiments, a provider of recommendations may receive interaction data from one or more stores or vendors related to purchases made by one or more Purchasers. Purchase data may include data on just recommended Products or on all items sold to the Purchaser. Similarly, Purchase data may include data based upon an aggregate of sales or sales related to specific Purchasers.

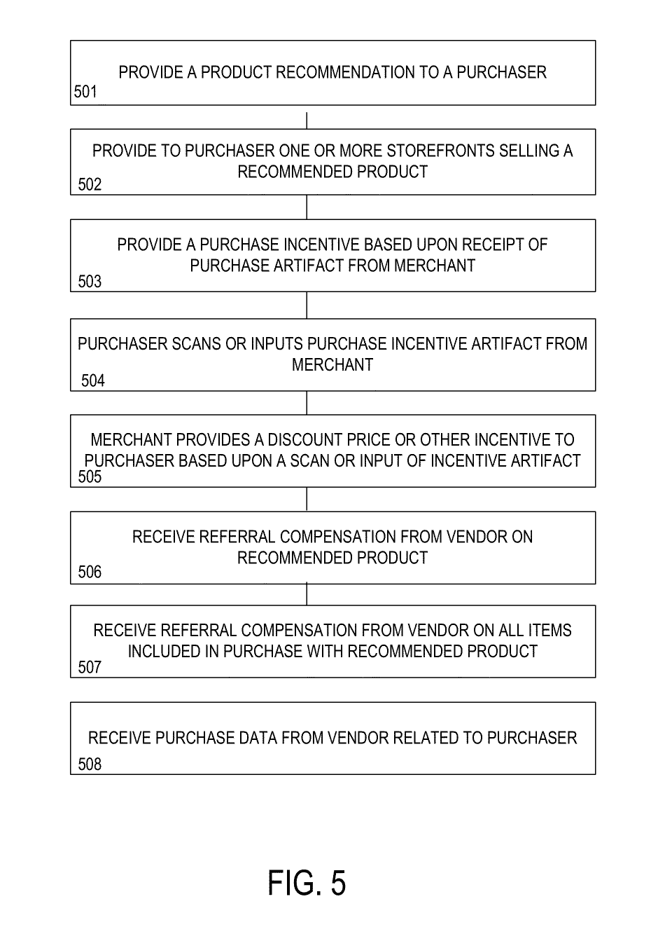

Referring now to FIG. 5, at 501, a server or other automated computer device, or online service, may provide to a Purchaser a Product recommendation. Product recommendations may include, for example, Products that are the subject of a promotion at the time of a Product inquiry, or a Product being actively marketed by a vendor local to the Purchaser.

At 502, the server may also provide to the Purchaser with data descriptive of one or more storefronts that sell a recommended Product. Additional data such as inventory data, product specifications, and images of the Product may also be included if desired.

At 503, a Purchase incentive artifact may also be provided to the Purchaser by a vendor. The Purchase incentive artifact may include, for example, a coupon, a bar code, a UUID, a purchase code, a hash mark or other artifact identifiable by the Local merchant.

At 504 the Purchaser may scan a purchase incentive artifact or input a code or otherwise quantify the Purchase incentive artifact and send a description of such artifact to the Product recommendation entity. At 505 the vendor provides a discount price or other incentive to the Purchaser based upon the incentive artifact. At 506, the Product recommending entity may receive a referral compensation, as described above, for the Product Purchase referral, or on an entire Purchase (at 507).

At 508, in some preferred embodiments, a provider of recommendations may receive purchase data from one or more vendors related to purchases made by one or more Purchasers. Purchase data may include data on just recommended Products or on all items sold to the Purchaser. Similarly, Purchase data may include data based upon an aggregate of sales or sales related to specific Purchasers.

A Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

A Purchaser may view details including functional ratings of Products being considered by the Purchaser. The details and ratings may be compiled from multiple sources, including, for example, manufacturer specifications, independent reviews, online blogs, government agencies, ratings entities, or other source.

A Purchaser may receive feedback related to Products of interest to the Purchaser. Feedback may include, for example, why a Product is recommended, or not recommended. Prices and purchasing deals for Products may be compared.

In some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, other multimedia device with user interactive controls, including, in some embodiments, voice activated interactive controls.

An exemplary user interactive interface may include multiple user interactive areas which may receive input from a user and provide one or both of human readable content or human recognizable images. Interactive areas may include, by way of non-limiting example, one or more of:

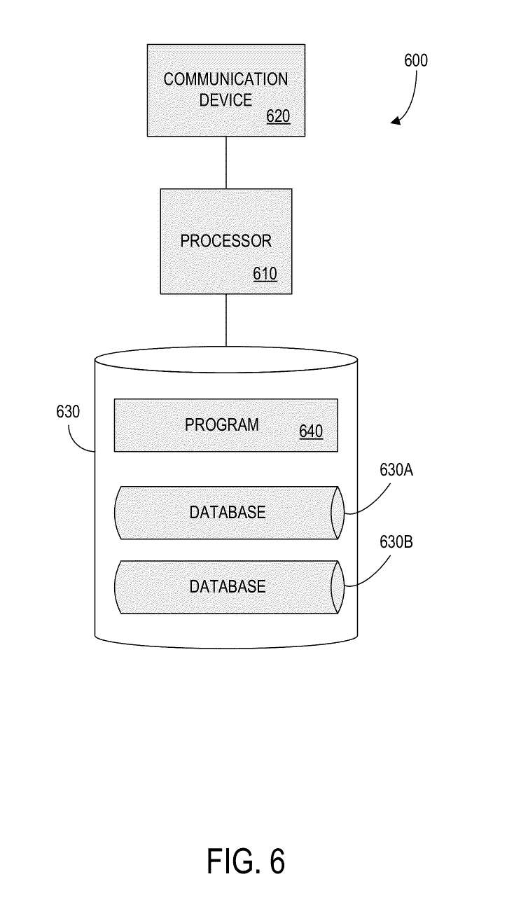

Referring now to FIG. 6, an illustration is provided with a controller 800 that may be embodied in one or more computer servers or communication network access devices and utilized to implement some embodiments of the present invention. A server may include, by way of example, a rack mounted server, stand alone server, a server farm or other embodiment of an automated apparatus for serving content on a communications network, such as the internet. Communications accessible devices may include, by way of example, a hand held device such as a cellular phone, a pad device, a personal computer, a server, a personal digital assistant, an electronic reader device or other programmable device.

The controller 600 comprises a processor unit 610, which may include one or more processors, coupled to a communication device 620 configured to communicate via a communication network, such as the Internet, or a other cellular based network such as a 3G or 4G network (not shown in FIG. 6). The communication device 620 may be used to communicate with a digital communications network, such as, for example, the Internet available via the Internet Protocol, or a cellular network such as 3G or 4G.

The processor 610 is also in communication with a storage device 630. The storage device 630 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 630 can store a program 640 for controlling the processor 610. The processor 610 performs instructions of the program 640, and thereby operates in accordance with the present invention. The processor 610 may also cause the communication device 620 to transmit information, including, in some instances, control commands to operate apparatus to implement the processes described above. The storage device 630 can additionally store related data in a database 630A and database 630B, as needed.

### Functional Diagram

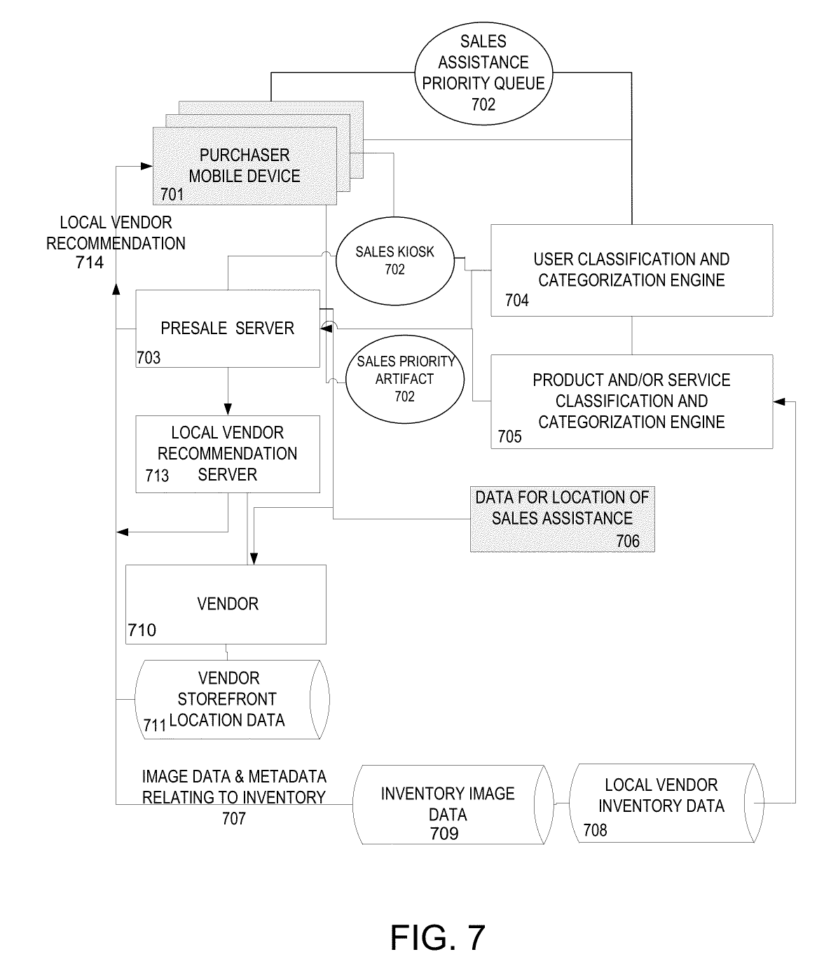

Referring now to FIG. 7, a functional block diagram illustrates aspects of the present invention wherein a Purchaser with a Purchaser Mobile Device 707 interacts with a virtual kiosk in the form of an interactive user interface. The Purchaser provides information descriptive of a desired sales transaction and a type of assistance requested. The Kiosk provides to the Purchaser a Sales Priority Artifact 702, such as a priority token indicating to the Purchaser a relative order of assistance to the Purchaser.

According to the present invention, a Presale Server 703 provides a Sales Priority Artifact 702 to a Purchaser Mobile Device 707. The Sales Priority Artifact 702 provides information to a Purchasers mobile device related to when a Purchaser will receive sales assistance.

In some embodiments, a Purchaser may also receive one or more Vendor recommendations 774 indicating a convenient storefront location where a Purchaser may purchase a Product. A Server 703 may identify a storefront that is in geographic proximity to the Purchaser Mobile Device 707, wherein the Vendor is identified as carrying a Product the Purchaser 707 has indicated the Purchaser desires to buy. Geographic proximity implies the Vendor is within a distance reasonable to travel to make a purchase based upon objective and subjective aspects of a purchase, which may include, for example a size of a purchase, the availability of a Product to be purchased and timing of when a Product is needed.

In some embodiments, a Purchaser may also receive a TPPI 702 for use with a purchase consummated at the vendor. The TPPI 702 may be redeemed via software executable via the Purchase Mobile Device 707, irrespective of a type of Point of Sale (POS) system being utilized by the vendor.

In another aspect, in some embodiments, the present invention may access data such as, Vendor location data 777 and Vendor inventory data 708 to determine which storefront may have a particular Product in stock. In addition, some embodiments may include access image data 709 descriptive of a recommended Product. Image Data and metadata 707 descriptive of a Product may therefore be transmitted to a Purchaser Mobile Device 707 for consideration by the Purchaser.

In another aspect of the present invention, data related to users of a system for providing Sales Priority Artifacts 702 may be collected and aggregated. A user classification and categorization engine 704 may be used to analyze and store data related to users of a system for providing purchase incentive artifacts 702 for local purchases.

Similarly, a Product and/or Service Classification and Categorization Engine 705 may be used to quantify and analyze data related to Products for which Purchase Incentive Artifacts are issued. The purchase related data may be stored and analyzed to understand usage trends and other data.

For example, data may be aggregated for all Sales Priority Artifacts requested and issued for one or more of, a given geographic area: a Product type, a specific Product, a brand of Product, a demographic associated with a Product, seasonal trends, location of a request for a Sales Priority Artifact, location of a Purchase of a Product in a transaction utilizing a Sales Priority Artifact, time of a request for a Purchase Incentive Artifact, time of a Purchase of a Product in a transaction utilizing a Sales Priority Artifact and other Sales Priority related data.

By way of illustrative example, as discussed more fully below, in some embodiments, the present invention may log a time and place that a user has requested a Sales Priority Artifact 702. For example, a geospatial recording from a Purchaser's Mobile Device may indicate that a Purchaser Mobile Device 70 is requesting a Sales Priority Artifact 702 from within the aisle of a brick and mortar store and also log a time of a request that a Purchaser Mobile Device 707 transmits a request for a Sales Priority Artifact 702.

In the discussion below, method steps that may be implemented in some embodiments are presented. The steps are not limited to any particular order unless other specified herein.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

What is claimed is:

1. Apparatus for providing automated presale assistance within a store location, the apparatus comprising:
a computerized server in logical communication with a digital communications network; and
executable software stored on the server and executable on demand, the software operative with the server to cause the apparatus to:
receive a Product description, identifying a Product, wherein the product description is received from a kiosk device within a store location;
receive a location of a Purchaser associated with the Product description and the request for sales assistance related to the Product;
receive a request for sales assistance related to the Product located within the store location; and
transmit one or more Sales Priority Artifacts related to the Product for use in conjunction with assistance to be provided to the Purchaser.

2. The apparatus of claim 1 wherein the software is additionally operative to transmit a specific store location at which the Sales Priority Artifact will be utilized.

3. The apparatus of claim 2 wherein the software is additionally operative to transmit data descriptive of costs associated with a purchase of the Product from the store location.

4. The apparatus of claim 2 wherein the software is additionally operative to identify a product based upon a scan of a product identifier with a mobile device operated by the Purchaser.

5. The apparatus of claim 1 wherein the product identifier comprises a barcode.

6. The apparatus of claim 1 wherein the software is additionally operative to to:
receive a redemption request for redeeming a Third Party Purchase Incentive Artifact; and
complete the terms of the redemption of the Third Party Purchase Incentive Artifact via digital communication between devices comprising the server and the user mobile device.

7. The apparatus of claim 1 wherein the software is additionally operative to transmit data descriptive of a history of sales associated with a particular purchaser.

8. The apparatus of claim 6 wherein the software is additionally operative to transmit a request for additional products offered at a storefront that are similar to the product identified.

9. The apparatus of claim 1 wherein the software is additionally operative to transmit data descriptive of aggregated data comprising multiple requests for sales assistance.

10. The apparatus of claim 1 wherein the software is additionally operative to aggregate data comprising a history of sales assistance events.

11. A method for providing automated presale assistance, the method comprising:
receiving into a computer server a Product description, identifying a Product, wherein the Product description is received from a user mobile device within a store location;
receiving a request for sales assistance related to the Product;
receiving data descriptive of a location of a Purchaser associated with the Product description and the request for sales assistance related to the Product; and
transmitting a Sales Priority Artifact related to the Product for use in conjunction with assistance to be provided to the Purchaser.

12. The method of claim 11 wherein the method additionally comprises the step of transmitting a specific store location at which the Sales Priority Artifact will be utilized.

13. The method of claim 12 wherein the method additionally comprises the step of transmitting data descriptive of costs associated with a purchase of the Product from the store location.

14. The method of claim 12 wherein the method additionally comprises the step of identifying a product based upon a scan of a product identifier with a mobile device operated by the Purchaser within the store location.

15. The method of claim 11 wherein the product identifier comprises an image of the product.

16. The method of claim 11 wherein the method additionally comprises the step of receiving a redemption request for redeeming a Third Party Purchase Incentive Artifact; and
completing the terms of the redemption of the Third Party Purchase Incentive Artifact via digital communication between devices comprising the server and the user mobile device.

17. The method of claim 11 wherein the method additionally comprises the step of transmitting data descriptive of a history of sales associated with a particular Purchaser.

18. The method of claim 16 wherein the method additionally comprises the step of transmitting a request for additional products offered at a storefront that are similar to the product identified.

19. The method of claim 11 wherein the method additionally comprises the step of transmitting data descriptive of aggregated data comprising multiple requests for sales assistance from the store location.

20. The method of claim 11 wherein the method additionally comprises the step of aggregating data comprising a history of sales assistance events associated with the store location.
